(19) United States
(12) Patent Application Publication
(10) Pub. No.: US 2019/0010754 A1
(43) Pub. Date: Jan. 10, 2019

(54) Uplift Prevention Device

(71) Applicant: Charles Nystrom, Edmonds, WA (US)

(72) Inventor: Charles Nystrom, Edmonds, WA (US)

(21) Appl. No.: 15/978,400

(22) Filed: May 14, 2018

Related U.S. Application Data
(60) Provisional application No. 62/529,056, filed on Jul. 6, 2017.

(51) Int. Cl. E06B 7/28; E06B 3/46

(52) U.S. Cl. CPC E06B 7/28; E06B 3/4609

(57) ABSTRACT

It is the object of the present invention to provide a sliding frame-mounted window uplift prevention device with improved structural integrity and strength, improved ease of installation and removal through elimination of mechanical fasteners such as screws, rivets, and the like, and compatibility with a wider variety of frame designs than existing devices.

### CROSS-REFERENCE TO RELATED APPLICATIONS

This application claims priority to U.S. Provisional Application No. 62/529,056 filed Jul. 6, 2017. The content of the above application is incorporated by reference in its entirety.

### FIELD OF THE DISCLOSURE

The overall prevention is in the field of sliding window and sliding door security devices and features.

### BACKGROUND

Windows and doors with horizontally sliding panes are generally designed such that the force of gravity is required to secure the sliding pane within its track. Typical horizontal sliding windows are fitted into a fixed outer frame that constrains and locates an inner sliding frame that houses the sliding pane. The sliding frame is supported at the bottom on rollers, bearings, or glides that move across a track at the bottom of the fixed frame. The fixed frame generally incorporate top and bottom channels that determine the plane to which the sliding frame movement is constrained. For reasons of manufacture and installation, the sliding and fixed frames require a nominal clearance gap within the top channel such that when the sliding frame is installed within the fixed frame, the sliding frame can be lifted upward, free of the track and bottom channel, and removed from the outer frame. This feature is beneficial in that it allows easy removal the sliding pane for exterior cleaning or repair. Unfortunately, this window uplift design feature provides a commonly exploited means for unauthorized ingress and presents a significant security concern.

Window uplift prevention devices are available to enhance window security. In general, uplift prevention devices aim to eliminate the gap above the sliding frame such that the sliding frame cannot be forced upward and removed. Some of these devices are mounted within the fixed frame, and exist to occupy the clearance gap in the top channel. Some of these devices are mounted to the sliding frame after it has been installed in the fixed frame. The top edge of the sliding frame is difficult or impossible to access after the sliding frame is installed. As such, most sliding frame-mounted uplift prevention devices are affixed to the vertical edge of the sliding frame. Great Britain patent number GB2453954 provides an example of a vertical edge-mounted device.

Uplift prevention devices that are affixed to the vertical edges of the sliding frame generally must be very securely mounted to the sliding frame because such a design lacks an integral structural element to resist uplift forces. Consequently, every available design that is affixed to the vertical edge of the sliding frame requires fasteners, such as screws, and tools for installation.

The fasteners in this application resist uplift forces by directly supporting shear forces between the frame and the device, as well as creating a static frictional force between the device and the frame due to the clamping force of the fastener. The fastener in this application is a critical structural component in resisting uplift prevention forces.

Therefore, proper installation of the fastener is critical to proper device function. Correct installation generally will require drilling a pilot hole, accurately sized and located. The location of the pilot hole must be correct in order to locate the device for proper operation. Additionally, the pilot hole must be located in a position such that an adequate depth of material is present to engage with the fastener. Often, these two requirements are mutually exclusive and the device cannot be securely fastened to the sliding frame because of the design features of the frame. Sliding frames are frequently hollow tubular material with thin walls or internal ribbing the will complicate or prevent screw installation. Other window designs have channels or grooves on the vertical edge of the sliding frame that prevent the uplift prevention device from being mounted flush to the surface that significantly compromise strength and complicate installation of the device. At a minimum, even in the event that the sliding frame is fully compatible with the device, proper installation procedure requires tools and at least a minimal level of ability to operate said tools and install the required fasteners.

GB2453954 also makes reference to an alternative embodiment that may be glued to the top edge of the sliding frame, but such a design significantly complicates installation and removal of the device due to the inaccessibility of the region above the upper edge of the sliding frame. This type of device would significantly compromise the benefits of a removable sliding pane as well as complicating the device installation.

### SUMMARY OF THE INVENTION

It is the object of the present invention to provide a sliding frame-mounted window uplift prevention device with improved structural integrity and strength, improved ease of installation and removal through elimination of mechanical fasteners such as screws, rivets, and the like, and compatibility with a wider variety of frame designs than existing devices.

Typical sliding window frames are removed by translating the sliding frame upward against gravity by some nominal amount, typically approximately ⅜″, which allows the lower edge of the sliding window frame to clear the lower track within which it runs. When the frame has cleared the lower track, it may be displaced laterally, approximately normal to the pane surface, and complete removal of the sliding windowpane is possible. The space between the upper edge of the sliding window frame and fixed frame must therefore be greater than the height required for clearing the lower track. Typically, this space above is approximately ½″.

The present invention occupies a portion of this space, approximately ¼″, above the sliding window frame. By occupying this space, the device interferes with and prevents the window removal process by preventing the window from being lifted a distance sufficient to allow it to be removed from its lower track. Additionally, the device may be securely mounted to the sliding window frame by simple adhesive or double-sided adhesive tape.

### BRIEF DESCRIPTION OF DRAWINGS

FIG. 1 Shows an isometric view of the window uplift prevention device.

FIG. 2 Shows a front and side view of the window uplift prevention device.

FIG. 3 Shows a view of the uplift prevention device as installed in a sliding window frame.

FIG. 4 Shows a view of the window uplift prevention device as installed on a sliding frame that is housed within its surrounding fixed frame with hidden lines shown.

### DETAILED DESCRIPTION

In the Summary above, this Detailed Description, claims below, and accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range including that number (which may be a range having an upper limit or no upper limit, depending on the variable being defined). For example, “at least 1” means 1 or more than 1. The term “at most” followed by a number is used herein to denote the end of a range, including that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose limits include both numbers. For example, “25 to 100” means a range whose lower limit is 25 and upper limit is 100, and includes both 25 and 100.

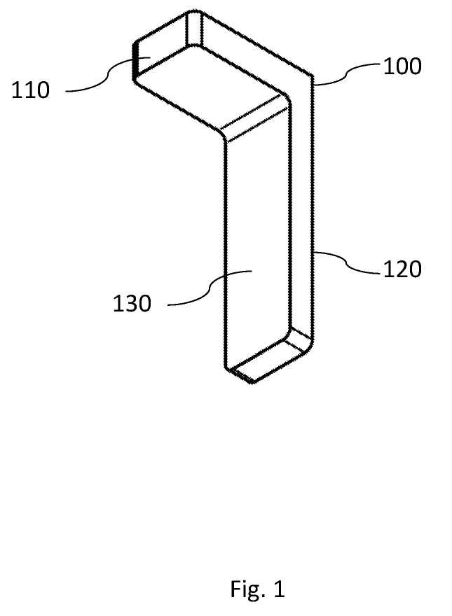

FIG. 1 shows an isometric view of the present invention, an uplift prevention device 100. The device is comprised of an interference tab 110 and a mounting tab 120, joined at a right angle. The mounting tab incorporates a mounting surface 130.

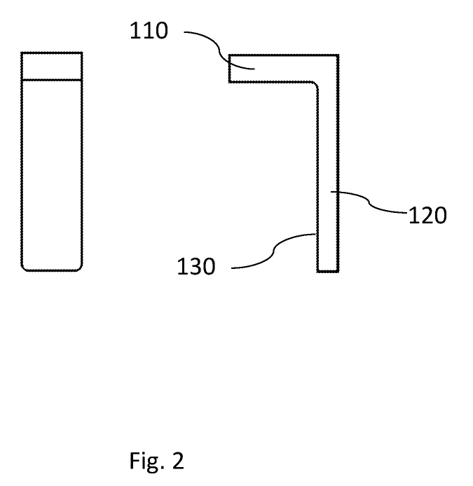

FIG. 2 shows a front and side view of the window uplift prevention device.

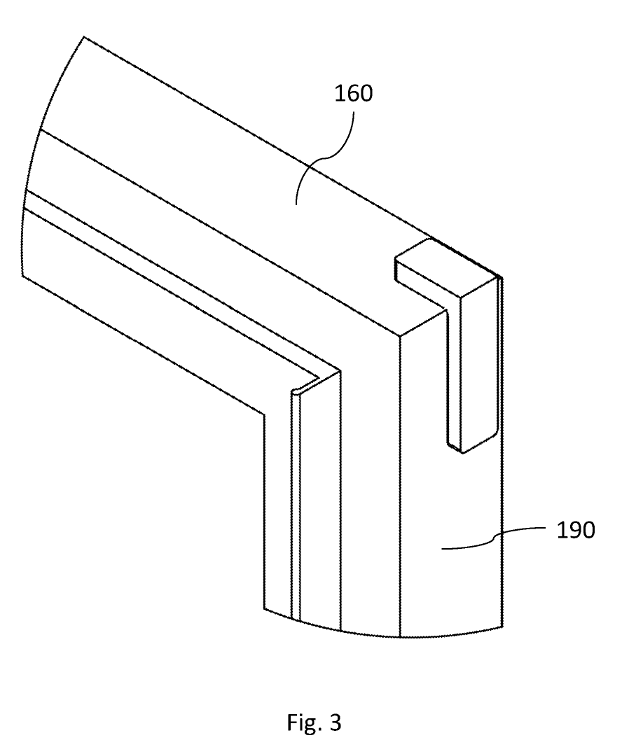

FIG. 3 shows a view of the uplift prevention device as installed on a sliding window frame.

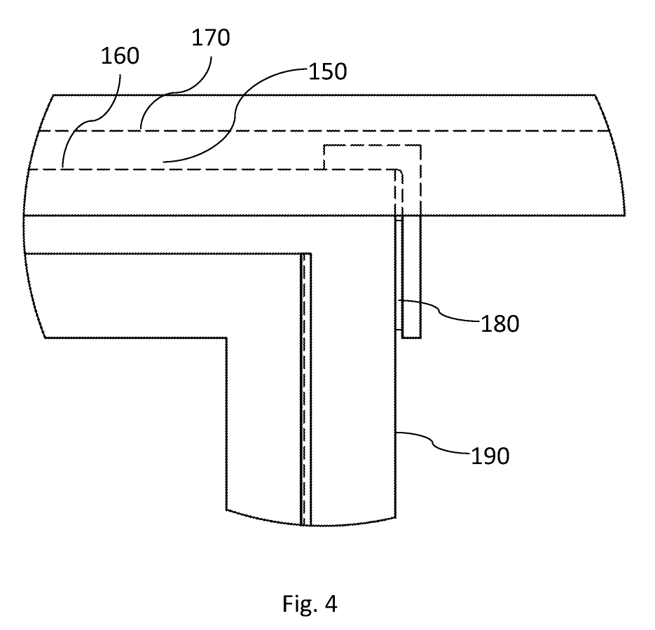

FIG. 4 shows a view of the window uplift prevention device as installed on a sliding frame that is housed within its surrounding fixed frame with hidden lines shown. The device operates by creating a structural element that exists in the vertical space 150 between the upper edge of the sliding frame 160 that surrounds the windowpane, and the adjacent edge of the surrounding fixed frame 170. The interference tab 110 serves to physically occupy a portion of the space 150 and has structural integrity sufficient to resist compressive forces typically encountered during a window removal procedure. The mounting tab 120, serves to provide a mounting surface 130 abutting the vertical edge of a sliding window frame 140. The mounting surface 130 serves to attach the uplift prevention device 100 using adhesive tape, gum, or liquid 180 to bond the mounting surface to the vertical edge of the sliding window frame 190. The mounting tab 120 and adhesive bond are sufficiently strong to resist nominal forces that are experienced during window opening and closing. When the device 100 is properly installed, the mounting tab 120 will not be subject to significant forces. The mounting tab 120 should not be required to resist uplift forces if window uplift is attempted. Therefore, structural demands on the tab 120 and the adhesive 180 bond to the window frame 190 are minimal.

In the preferred embodiment, the adhesive bond is strong enough to keep the uplift prevention device in position during normal operation of the sliding window, but weak enough to allow a user to readily break the bond if window removal is desired. The device may be reinstalled when desired by either reusing existing adhesive or by applying new adhesive to reattach the device to the sliding window frame.

The device is preferably made from solid plastic. Alternative embodiments of the device may be made from metal, ceramic, wood, composite, or any other material of sufficient structural integrity to support and resist forces encountered during normal operation. The device may be solid or hollow. The device may be monolithic or comprised of multiple pieces that are mechanically joined.

### Preferred Method of Use

In the preferred method of use, the uplift prevention device is installed as shown in FIG. 5 using double-sided adhesive tape.

While preferred and alternate embodiments have been illustrated and described, as noted above, many changes can be made without departing from the spirit and scope of this UPLIFT PREVENTION DEVICE. Accordingly, the scope of the UPLIFT PREVENTION DEVICE is not limited by the disclosure of these preferred and alternate embodiments. Instead, the scope of the UPLIFT PREVENTION DEVICE is to be determined entirely by reference to the claims. Insofar as the description above and the accompanying drawings (if any) disclose any additional subject matter that is not within the scope of the claims below, the inventions are not dedicated to the public and Applicant hereby reserves the right to file one or more applications to claim such additional inventions.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example of a generic series of equivalent or similar features.

Any element in a claim that does not explicitly state “means for” performing a specified function, or “step for” performing a specific function is not to be interpreted as a “means” or “step” clause as specified in 35. U.S.C. § 112 ¶ 6. In particular, the use of “step of” in the claims herein is not intended to invoke the provisions of U.S.C. § 112 ¶ 6.

1. A window uplift prevention device comprising:
an interference tab disposed horizontally and adapted to abut an upper edge surface of a slidable window frame,
said interference tab being adapted to occupy at least 3/32 inch of a vertical clearance above said upper surface of said slidable window frame,
a mounting tab extending downward at a right angle from said interference tab, adapted to abut a vertical edge surface of said slidable window frame adjacent to said upper surface,
said mounting tab having a mounting surface adapted to accept an adhesive media,
said adhesive media being adapted to adhere said mounting surface to said vertical edge surface of said slidable window frame.

2. The window uplift prevention device of claim 1 wherein the interference tab and the mounting tab are integrally formed as a continuous solid body.

3. The window uplift prevention device of claim 2 wherein said continuous solid body is formed from a plastic material.

4. The window uplift prevention device of claim 3 wherein said adhesive media is a double-sided adhesive tape.

5. The window uplift prevention device of claim 4 wherein said double-sided adhesive tape is a double-sided foam mounting tape.

6. The window uplift prevention device of claim 4 wherein said double-sided adhesive tape is a double-sided acrylic tape.

7. The window uplift prevention device of claim 5 wherein said interference tab has a thickness between ⅛ inch and 5/16 inch.

8. A window assembly comprising:
a slidable window frame located within a guide track of a fixed window frame having a vertical clearance between said upper edge of the slidable frame and said fixed window frame, said clearance being adapted to allow a vertical displacement of said slidable window frame sufficient to unseat said slidable window frame from said guide track,
an interference tab, located within said vertical clearance and having sufficient thickness and material integrity to interfere with said vertical displacement sufficiently to render unseatment of said slidable window frame from said guide track impossible,
said slidable window frame having a vertical edge extending downward from said upper edge,
said interference tab being positioned at an upper corner of said slidable window frame,
a mounting tab attached at a right angle to said interference tab and extending downward along said vertical edge, and
an adhesive applied to said mounting tab such that the mounting tab adheres to said vertical edge.

9. The window assembly of claim 8 wherein said interference tab and said mounting tab are integrally formed as a continuous solid body.

10. The window assembly of claim 9 wherein said continuous solid body is comprised of a plastic material.

11. The window assembly of claim 10 wherein said adhesive media is a double-sided adhesive tape.

12. The window assembly of claim 11 wherein said double-sided adhesive tape is a double-sided foam mounting tape.

13. The window assembly of claim 11 wherein said double-sided adhesive tape is a double-sided acrylic tape.

14. The window assembly of claim 12 wherein said interference tab has a thickness between ⅛ inch and 5/16 inch.
